(19) United States
(12) Patent Application Publication
(10) Pub. No.: US 2003/0083939 A1
(43) Pub. Date: May 1, 2003

(54) Automated lost property recovery and marketing system and program

(76) Inventor: Gregory Wohl, Tampa, FL (US)

Correspondence Address: Arthur W. Fisher, Suite 316, 5553 West Waters Avenue, Tamp, FL, 33634, US

(21) Appl. No.: 10/022,128

(22) Filed: Oct. 30, 2001

(51) Int. Cl. G06F 17/60

(52) U.S. Cl. 705/14

(57) ABSTRACT

An automated lost property recovery and marketing system and program managed by an administrator to create a database of participants to provide targeted promotions and advertising of goods/services of a corresponding sponsor to a defined universe of targeted participants including a database function to create and maintain the database of targeted participants, a lost property recovery function to return lost property to a participant having lost property and a promotions and advertising function to selectively communicate promotional information to the defined universe of targeted participants.

### BACKGROUND OF THE INVENTION

1. Field of the Invention

An automated lost property recovery and marketing database program and system managed by an administrator to create a database of participants to provide targeted promotions and advertising of goods/services of a corresponding sponsor to a defined universe of targeted participants.

2. Description of the Prior Art

Various marketing and advertising programs have been created in an effort to determine the most effective and cost effective mode of increasing sales.

For example, display advertising is widely employed due to the ability to reach a broad range of potential customers. Unfortunately, display advertising is limited in that an advertiser cannot accurately gauge the success of any particular display ad. The mere fact that many people see the ad serves as a basis for the hope that the ad is effective. The advertiser, however, does not have any precise means of determining if business has increased due to a particular display ad. This limitation of display ads is a result of the random nature of the viewing of such display ads.

More effective display ads are generally those that advertise products or services that are targeted to a particular audience, such as where sportswear companies may target potential customers at sporting arenas and stadiums.

A number of patents directed to increasing cost effectiveness of advertising and promotions have been issued.

U.S. Pat. No. 4,650,219 shows a system to facilitate notification of the parents of a lost child comprising an alphanumeric marking (ID marking) on an item of clothing of a particular child, the ID marking being unique to the particular child but not containing the child's name. An alert marking, similar to alert markings on other children's clothing that have an ID marking, alerts authorities who find a lost child that an ID marking is present and indicates where it is located, such as hidden within a pocket. Authorities finding the child with the alert marking are directed to the ID marking, are able to contact a central station which can notify the parents of the child that the child has been found. The ID marking can be generated from a credit card number of a parent by a formula that permits knowledge of the ID marking to be used to generate enough of the credit card number of the parent to identify him or her.

U.S. Pat. No. 5,036,610 teaches a system for identifying a lost pet and locating its owner comprising a central clearing house and a pet collar or tag having a telephone number and a unique code number imprinted thereon. Information about the pet and its owner is stored at the central clearinghouse under the unique number and is retrievable in response to a telephone call from a finder of the pet.

U.S. Pat. No. 5,369,900 shows a tamper-resistant owner identification badge for bicycles comprising a hardened steel badge embossed with a registration number, a reward offer, and a toll-free phone number. An aluminum sticker inscribed with the owner's personal information is attached to the badge. The badge, formed by two opposing casing members, is mounted around the seatstay tube of a bicycle. Two screws sunken into counterbores hold the casing members firmly together. Sealing discs tapped flush into the counterbores permanently deny access to the screws, so that removal of the badge is extremely difficult for even the most experienced thieves. The personal information on the badge provides anyone who sees the bicycle, but particularly law enforcement authorities, a means to compare the person possessing the bicycle with the characteristics of the rightful owner. Even if the sticker is removed, the reward offer and the toll-free number will help to induce any person who finds the bicycle to report the discovery.

U.S. Pat. No. 5,570,081 teaches an improved recovery system utilizing a two-piece detachable card. A base and tag are snapped apart at a groove into two separate pieces. A tag is attached to an article such as a standard key ring via a through-hole. A base is retained in a secure place. If the article is lost a finder is asked to follow a specific course of action. Listed on the back of the tag is a finder call number. The finder is prompted be the written words “if found, please call . . . .” And a toll-free telephone number is listed. Upon calling the number from a touch-tone telephone, the finder is instructed to punch in the tag number. The tones generated by punching in an activated tag number cause a specific voice mail box to be created within the computer. The finder is further instructed to leave a brief voice message providing a phone number or location where the “found” article can be recovered. Subsequently and upon discovering the loss of an article, the owner retrieves the base and calls the owner call number. Upon connection to the computer, the owner is instructed to punch in the base number. The tones generated by punching in the base number will cause the computer to automatically search and locate any voice messages in the newly-created tag number voice mail box. If a message is present the owner will hear it. If no messages have been recorded, the owner will be informed and asked to check back at a later time.

U.S. Pat. No. 5,816,620 shows the present invention relates to a key locator having a tag. A key attachment means is securely attached to the tag and at least one key is securely attached to the key attachment means. At least one set of instructions is inscribed on the tag. The tag includes a mailing address and has mailing address postage indicia inscribed on the tag. A microchip that comprises a user's personal identifier therein embedded with the tag. A bar code which comprises a user's personal identifier therein inscribed on the tag, along with a magnetic strip which also has an user's personal identifier therein recorded. A method is included describing the method to record the user's personal identifier onto the tag.

U.S. Pat. No. 5,878,116 teaches a method of locating a lost item via a provided telephone service, using an identification number given on both an identification card held by the owner of the item, and on an identification tag worn or attached to the item. A telephone number is given on the identification card for the item owner to access the telephone service and open a voice mailbox under the identification number, and a telephone number is given on the identification tag for the finder of the item to access the telephone service and leave a message with the telephone service (either in the opened voice mailbox or with the service if the finder calls before the item owner opens the voice mailbox) regarding the whereabouts of the lost item.

U.S. Pat. No. 5,912,956 shows a system and method for anonymously establishing telephonic connections includes a plurality of identification tags, a master control telephone calling card, a computer-executable program, a voice synthesizer and a telephone switch. The identification tags are carried by persons, pets or objects and each include unique visible indicia which provide instructions on how a holder or finder of an identification tag can make a toll-free telephone call to a person responsible for the person, pet or object carrying the identification tag. The visible indicia also include a simplified menu of system inputs. The system employs the computer-executable program and the voice synthesizer to interactively prompt a caller to select and enter inputs from the menu shown on the tag. The system then employs the selected inputs and stored data accessible to the computer executable program to anonymously establish telephonic connections at the telephone switch between the caller and a person responsible for the person, pet or object associated with the tag. The master control card is provided to a system subscriber and has visible indicia including a master control personal identification number (PIN). When the master control PIN is provided to the system, a different portion of the computer-executable program is executed thereby enabling the system subscriber to remotely change the stored data exploit other system features which are inaccessible to holders of the identification tags.

U.S. Pat. No. 6,064,307 teaches a method for relating about an article to a finder of that object, person, or animal including providing an identification device proximate the article. Providing the identification device with a telephone number, code, and instruction for the finder of the article to call the telephone number. Using the telephone number to link the finder to a clearinghouse. The clearinghouse prompts the finder to enter the code. Using the code, the clearinghouse accesses information about the article and forwards the call to the proper recipient of the call.

U.S. Pat. No. 5,809,481 shows a method and system for advertising that provides advertisers with a marketing database listing contact information for all potential consumers who received a promotional item from that advertiser and decided to retain the promotional item for future use. The promotional item is a tag bearing an advertisement, a contact identifier and a unique tag identifier. After receiving the tag from an advertiser, each recipient is instructed to attach the tag to a personal item and to register the item with a processing facility that, with the use of an information storage and retrieval system, will create a master database comprising each recipient's contact information and tag identifier. The master database can be used to arrange for the return of a lost personal property item bearing a registered tag. The master database can also be sorted and contact information can be extracted therefrom to generate a marketing database for transmittal to advertisers.

JP 01225984A teaches how to collect a lost article by registering a series of marks stated on the tag and the address of a user who joins this liaison tag system at the same time.

### SUMMARY OF THE INVENTION

The present invention relates to an automated lost property and marketing database program or system managed by an administrator to create a database of participants to provide targeted promotions and advertising of goods/services of a corresponding sponsor to a defined universe of targeted participants. The system comprises an interactive and permission based advertising medium utilizing the internet. The system features a lost and found recovery procedure, a current and active e-mail database and e-mail promotion and advertising.

The system uses attractive tags and self-adhesive labels to identify lost and recovered items. The tags and self-adhesive labels are attached to the participant's items of value such as key chains, cell phones, lap top personal computers, luggage, books, bicycles, brief cases, pagers and various sporting goods. Each tag and label has a unique, securely coded identification number, which identifies a particular participant. Registration of these items online with the system administrator or service provider through the internet increases the likelihood of a safe return to the participant.

E-mail addresses are acquired by the administrator during the registration process enabling sponsors to develop a unique permission based advertising campaign directed to the participants sponsored by a particular or specific sponsor.

The tags and labels are marked with a toll-free number to contact when an item is found. Finders are instructed to call this toll-free number and enter the corresponding coded identification number. The automated system then identifies the participant and creates a personal property voice mailbox. The system will prompt finders to leave a detailed message with a preferred method of contact. Any participant who has lost property is instructed to periodically check the automated system for a personalized mailbox that will contain a recorded message if a recovered item has been reported. E-mail notices will also be automatically sent from the administrator to the particular participant upon notification of a found item. Only registered and reported properties have voice mailboxes created.

The system also provides sponsors with a high impact, targeted E-mail based marketing program. Each campaign's message can be tailored to a unique target audience by the specific sponsor. Proprietary coding can be set up to help distinguish prospects, existing customers or any other type of segmentation that may be needed within any sponsor's database. This allows each E-mail message to be customized.

The present invention is useful in customer retention, trade show promotion, goodwill/enhanced image, create awareness of new product or services, reinforce existing product/services/facilities, generate sales leads and responses, fundraising, and motivating dealers, retailers, increase store traffic, and opening doors and securing appointments.

When properly used, the present invention can reach millions of targeted registrants of corresponding sponsors with daily logo exposure of the tags and labels, greatly reducing the cost per impression, produce immediate results with the easy to implement turn-key program to create a valuable prospect or customer database. The system also provides measurable results, saves money—E-mail costs less than traditional direct mail, saves time—E-mail campaigns can be completed within hours, creates synergy when integrated with other forms of advertising, increases sales revenues, provides customers with a valuable lost property recovery service and bonds sponsors with a targeted defined database of registrants.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIGS. 1A through 1C depict a flow chart of the automated lost property recovery and marketing system of the present invention.

FIG. 2 depicts a label for use with the automated lost property recovery and marketing system of the present invention.

FIGS. 3A and 3B depict a tag for use with the automated lost property recovery and marketing system of the present invention.

FIGS. 4A through 4E depict prompt elements of a screen for entry of information of a participant into the database for use with the automated lost property recovery and marketing system of the present invention.

FIG. 5 depicts an information and retrieval system for use with the automated lost property recovery and marketing system of the present invention.

Similar reference characters refer to similar parts throughout the several views of the drawings.

### DETAILED DESCRIPTION OF THE PREFERRED EMBODIMENT

The present invention relates to an automated lost property recovery and marketing program or system managed by an administrator or service provider to create a database of sponsor selected participants to provide targeted promotions and advertising of goods/services of the corresponding sponsor to a defined universe of targeted participants. As discussed more fully hereinafter, the automated lost property recovery and marketing system includes a database function to create and maintain a database of targeted participants, a lost property recovery function to return lost property to a participant having lost property and a promotions and advertising function to selectively communicate promotional information to the defined universe of targeted participants or selected members of the defined universe of targeted participants.

The automated lost property recovery and marketing system involves at least one entity seeking to establish a defined database of selected target customers or potential customers for the sponsor's products and/or services to receive promotional and advertising material hereinafter referred to as a sponsor, a plurality of target customers or potential customers hereinafter referred to as participants who are selected by the sponsor to receive promotional and advertising material and who elect to register in the database and a service provider to manage the database, lost property and promotional and advertising functions hereinafter referred to as administrator.

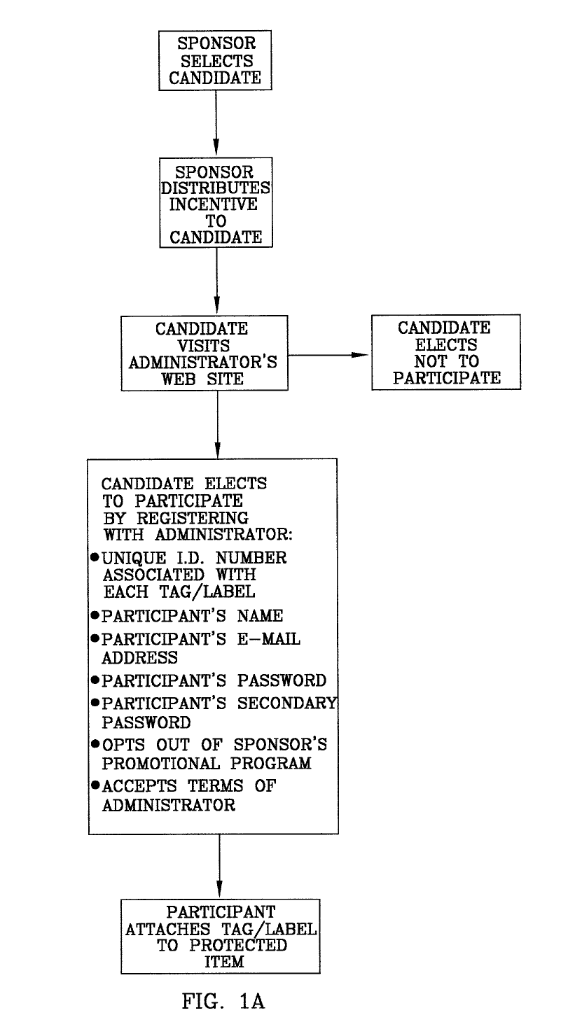

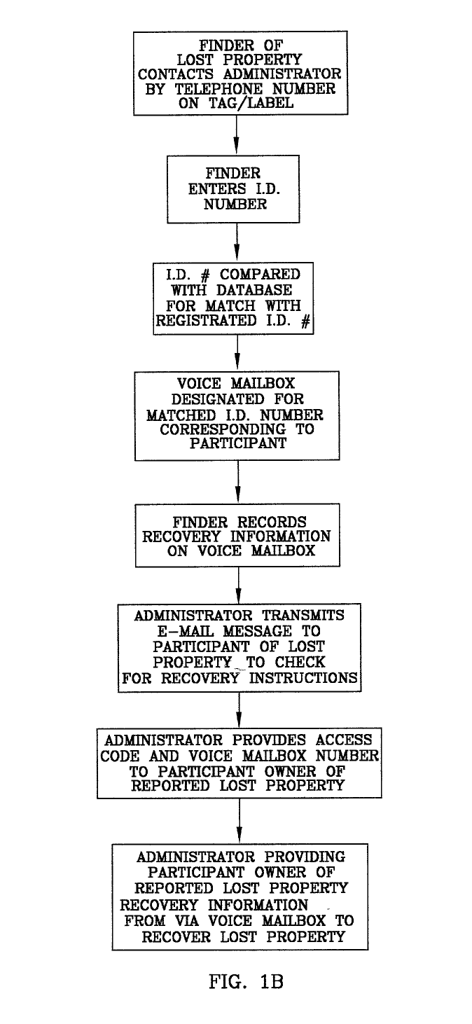

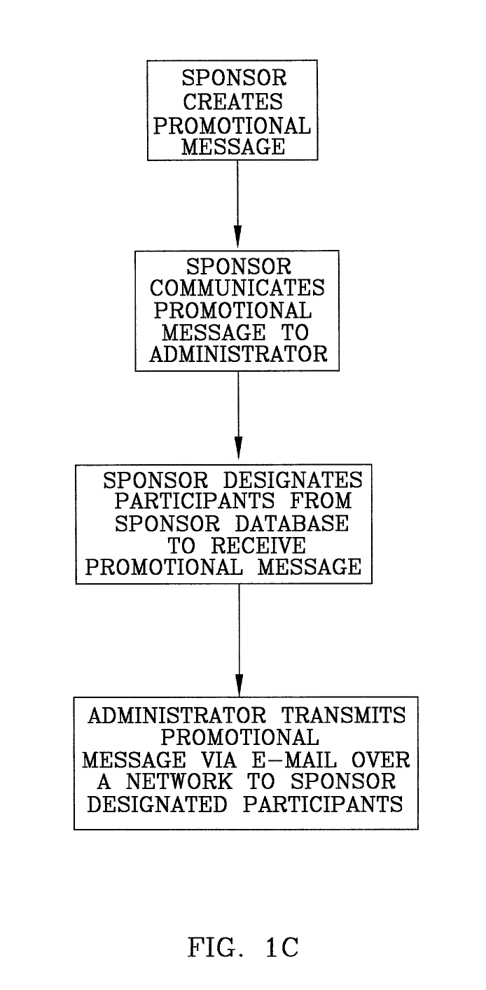

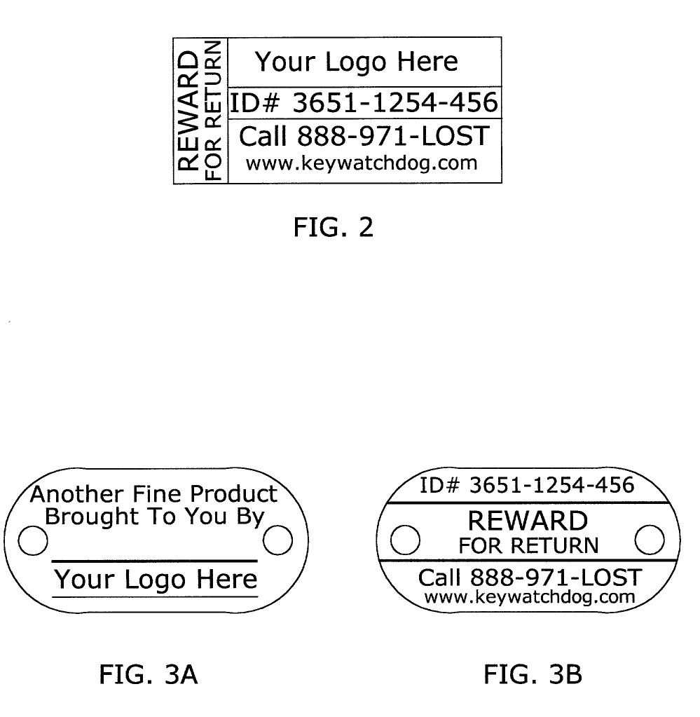

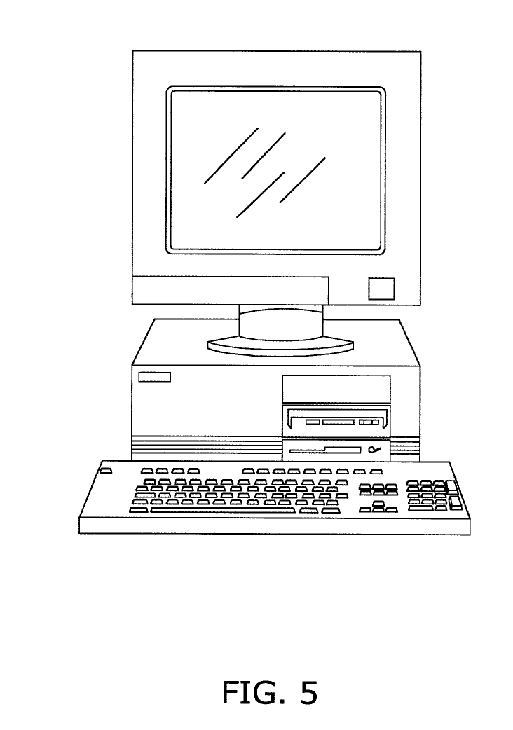

FIGS. 1A through 1C depict the steps of the three functions by which the automated lost property recovery and marketing system is implemented. Specifically, the sponsor selects persons who are candidates for participants to receive an incentive such as a tag shown in FIG. 2 or a label shown in FIGS. 3A and 3B for use in the lost function in return for agreeing to receive E-mail promotional material for the sponsor for use in the promotion or advertising function. The sponsor then distributes the tag(s) and/or label(s) to the selected person(s) who, in turn, registers over the internet with the administrator by entering specific fields of information into the database maintained by the administrator through the use of a personal computer such as shown in FIG. 5. It should be noted that the tag(s) and label(s) bear the trade identification or other sponsor provided information as a constant promotional reminder.

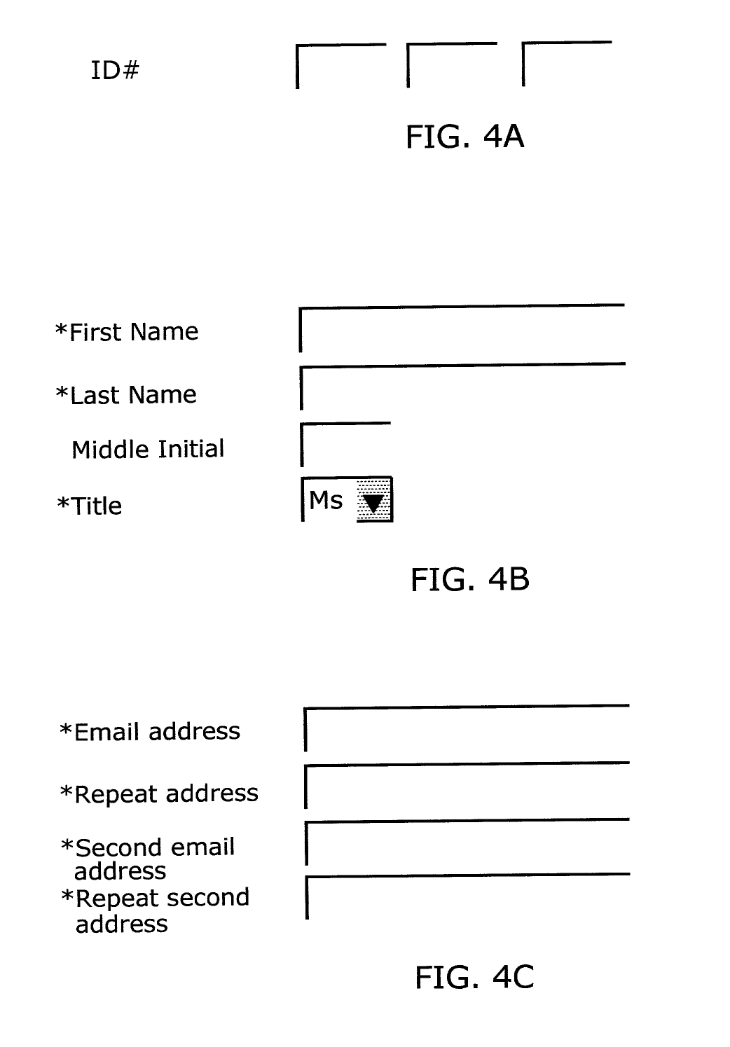

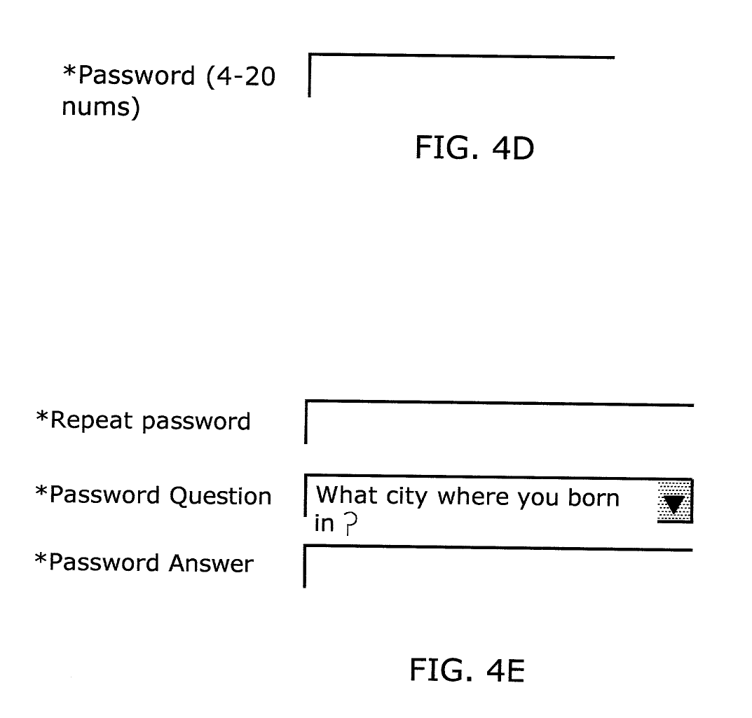

As shown in FIGS. 4A through 4E, the specific fields of registration information include the unique tag or label identification number from the tag(s) or label(s), FIG. 4A, the participant's name and title, FIG. 4B, the participant's E-mail address, FIG. 4C, the participant's password, FIG. 4D, and the participant's default or secondary password, FIG. 4E. The participant is advised that the sponsor has requested the exclusive use of the E-mail address to offer or promote products, services, and the like to the participants in exchange for the lost and found service. A participant can opt out of the promotional E-mail service and remain enrolled in the lost property receiving service only.

The candidate is then informed of the terms and conditions of the program. If the candidate indicates acceptance of the posted terms and conditions, the candidate's data is entered into the database and the candidate becomes a participant. Finally, the participant attaches the protected item of property to the tag or label, FIGS. 3A and 3B.

Once a database of participants for a sponsor is created, the administrator implements and manages the lost property recovery function and the promotions and advertising function for the participants for that particular sponsor.

All the tags and labels bear the unique, security coded number, associated with a particular owner or participant and a toll-free number to be called when a tagged or labeled item is found. Finders are requested to call this toll-free number and enter the ID# from the tag or label. The automated lost property recovery function compares the ID number with the ID numbers within the database to determine a match or incident. If a match or incident if found, the owner is identified and a personal property voice mailbox is designated. The system then prompts the finder to leave a message as to how to recover or to retrieve the lost article or item. Participants who have lost property, are instructed to periodically check their E-mail which, when updated, will contain a code and phone number to retrieve a personalized message from the designated personal property voice mailbox. Only registered, found, and reported properties will have designated mailboxes.

All finders will be enrolled in the lost property recovery function.

With a sponsor database created, the sponsor is able to select any demographic profile of participants from the sponsor database to receive an E-mail promotion, advertisement or other message. Of course, the entire sponsor database can be designated to receive the sponsor's message. In particular, the sponsor provides the administrator with a prepared/approved message to be transmitted by the administrator to those participants from the sponsor's database designated either individually or by class or category.

The process or steps of the database function of the automated lost property recovery and marketing program or system comprise: (1) sponsor selects candidate; (2) sponsor distributes incentive to candidate; (3) candidate visits administrator's web site and selects whether or not to continue to participate; (4) if candidate elects to participate, the candidate registers with the administrator by entering the unique ID number associated with each tag/label, participant's E-mail address, password and security password; (5) selectively opts out of sponsor's promotional program; and (6) attaches the tag/label to protect the particular item(s).

The process or steps of the lost property recovery function of the automated lost property recovery and marketing program or system comprise: (1) finder of lost property contacts administrator by calling the telephone number on the tag or label attached to the found item; (2) finder enters the ID number from the tag or label; (3) ID number is compared with the database for matching against registered ID numbers; (4) voice mailbox designated for matched ID number is activated; (5) finder records information on voice mailbox; (6) administrator provides access code and voice mailbox number to participant of notification of found property; (7) participants accesses voice mailbox and retrieves finder information; and (8) participant contacts finder to recover lost item.

The process or steps of the promotions and advertising function of the automated lost property recovery and marketing program or system comprise: (1) sponsor creates promotional message; (2) sponsor communicates promotional message to administrator; (3) sponsor designates participants from sponsor database to receive promotional message; (4) administrator transmits promotional message via E-mail over administrator's network to sponsor designated participants.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. An automated lost property recovery and marketing program or system managed by an administrator provider to create a database of sponsor selected participants to provide targeted promotions and advertising of goods/services to a defined universe of targeted participants, said automated lost property recovery and marketing system comprises a database function to create and maintain a database of targeted participants, a lost property recovery function to return lost property to a participant having lost property and a promotions and advertising function to selectively communicate promotional information to the defined universe of targeted participants or selected members of the defined universe of targeted participants.

2. The automated lost property recovery and marketing system of claim 1 wherein at least one entity seeking to establish a defined database of selected target customers or potential customers for the sponsor's products and/or services to receive promotional and advertising material comprising said sponsor, a plurality of target customers or potential customers comprising said participants selected by the sponsor to receive promotional and advertising material and who elect to register in the database and a service provider to manage the database, lost property and promotional and advertising functions comprises said administrator.

3. The automated lost property recovery and marketing system of claim 1 wherein said database function sponsor selecting candidates and distributing incentives to candidates; and candidates visiting administrator's web site and electing to participate.

4. The automated lost property recovery and marketing system of claim 3 wherein said database function further includes candidates registering with the administrator by entering said unique ID number associated with a tag or label to be attached to a protected item, E-mail address and password.

5. The automated lost property recovery and marketing system of claim 3 wherein said database function comprises said participant selecting to opt out of sponsor's promotional program.

6. The automated lost property recovery and marketing system of claim 3 wherein said lost property recovery function comprises finder of lost property contacting administrator by calling the telephone number on the tag or label attached to the found item; finder entering the ID number from the tag or label; ID number compared with the database for matching against registered ID numbers; voice mailbox designated for matched ID number is activated; finder recording information on voice mailbox; administrator providing access code and voice mailbox number to participant of notification of found property; participants accessing voice mailbox and retrieving finder information; and participant contacting finder to recover lost item.

7. The automated lost property recovery and marketing system of claim 6 wherein said promotions and advertising function comprises: sponsor creating promotional message; sponsor communicating promotional message to administrator; sponsor designating participants from sponsor database to receive promotional message; administrator transmitting promotional message via E-mail over administrator's network to sponsor designated participants.

8. An automated lost property recovery and marketing program or system managed by an administrator provider to create a database of sponsor selected participants to provide targeted promotions and advertising of goods/services to a defined universe of targeted participants, said automated lost property recovery and marketing system comprises a database function to create and maintain a database of targeted participants, a lost property recovery function to return lost property to a participant having lost property and a promotions and advertising function to selectively communicate promotional information to the defined universe of targeted participants or selected members of the defined universe of targeted participants and at least one entity seeking to establish a defined database of selected target customers or potential customers for the sponsor's products and/or services to receive promotional and advertising material comprising said sponsor, a plurality of target customers or potential customers comprising said participants selected by the sponsor to receive promotional and advertising material and who elect to register in the database and a service provider to manage the database, lost property and promotional and advertising functions comprises said administrator.

9. The automated lost property recovery and marketing system of claim 8 wherein said database function sponsor selecting candidates and distributing incentives to candidates; and candidates visiting administrator's web site and electing to participate.

10. The automated lost property recovery and marketing system of claim 9 wherein said database function further includes candidates registering with the administrator by entering said unique ID number associated with a tag or label to be attached to a protected item, E-mail address and password.

11. The automated lost property recovery and marketing system of claim 9 wherein said database function comprises said participant selecting to opt out of sponsor's promotional program.

12. The automated lost property recovery and marketing system of claim 9 wherein said lost property recovery function comprises finder of lost property contacting administrator by calling the telephone number on the tag or label attached to the found item; finder entering the ID number from the tag or label; ID number compared with the database for matching against registered ID numbers; voice mailbox designated for matched ID number is activated; finder recording information on voice mailbox; administrator providing access code and voice mailbox number to participant of notification of found property; participants accessing voice mailbox and retrieving finder information; and participant contacting finder to recover lost item.

13. The automated lost property recovery and marketing system of claim 12 wherein said promotions and advertising function comprises: sponsor creating promotional message; sponsor communicating promotional message to administrator; sponsor designating participants from sponsor database to receive promotional message; administrator transmitting promotional message via E-mail over administrator's network to sponsor designated participants.

14. An automated lost property recovery and marketing program or system managed by an administrator provider to create a database of sponsor selected participants to provide targeted promotions and advertising of goods/services to a defined universe of targeted participants, said automated lost property recovery and marketing system comprises a database function to create and maintain a database of targeted participants, a lost property recovery function to return lost property to a participant having lost property and a promotions and advertising function to selectively communicate promotional information to the defined universe of targeted participants or selected members of the defined universe of targeted participants and at least one entity seeking to establish a defined database of selected target customers or potential customers for the sponsor's products and/or services to receive promotional and advertising material comprising said sponsor, a plurality of target customers or potential customers comprising said participants selected by the sponsor to receive promotional and advertising material and who elect to register in the database and a service provider to manage the database, lost property and promotional and advertising functions comprises said administrator; said database function sponsor selecting candidates and distributing incentives to candidates; and candidates visiting administrator's web site and electing to participate; said database function further including candidates registering with the administrator by entering said unique ID number associated with a tag or label to be attached to a protected item, E-mail address and password; and said database function comprises said participant selecting to opt out of sponsor's promotional program.

15. The automated lost property recovery and marketing system of claim 14 wherein said lost property recovery function comprises finder of lost property contacting administrator by calling the telephone number on the tag or label attached to the found item; finder entering the ID number from the tag or label; ID number compared with the database for matching against registered ID numbers; voice mailbox designated for matched ID number is activated; finder recording information on voice mailbox; administrator providing access code and voice mailbox number to participant of notification of found property; participants accessing voice mailbox and retrieving finder information; and participant contacting finder to recover lost item.

16. The automated lost property recovery and marketing system of claim 15 wherein said promotions and advertising function comprises: sponsor creating promotional message; sponsor communicating promotional message to administrator; sponsor designating participants from sponsor database to receive promotional message; administrator transmitting promotional message via E-mail over administrator's network to sponsor designated participants.

17. An automated lost property recovery and marketing program or system managed by an administrator provider to create a database of sponsor selected participants to provide targeted promotions and advertising of goods/services to a defined universe of targeted participants, said automated lost property recovery and marketing system comprises a database function to create and maintain a database of targeted participants, a lost property recovery function to return lost property to a participant having lost property and a promotions and advertising function to selectively communicate promotional information to the defined universe of targeted participants or selected members of the defined universe of targeted participants and at least one entity seeking to establish a defined database of selected target customers or potential customers for the sponsor's products and/or services to receive promotional and advertising material comprising said sponsor, a plurality of target customers or potential customers comprising said participants selected by the sponsor to receive promotional and advertising material and who elect to register in the database and a service provider to manage the database, lost property and promotional and advertising functions comprises said administrator; said database function sponsor selecting candidates and distributing incentives to candidates; and candidates visiting administrator's web site and electing to participate; and said database function comprises said participant selecting to opt out of sponsor's promotional program.

18. The automated lost property recovery and marketing system of claim 17 wherein said lost property recovery function comprises finder of lost property contacting administrator by calling the telephone number on the tag or label attached to the found item; finder entering the ID number from the tag or label; ID number compared with the database for matching against registered ID numbers; voice mailbox designated for matched ID number is activated; finder recording information on voice mailbox; administrator providing access code and voice mailbox number to participant of notification of found property; participants accessing voice mailbox and retrieving finder information; and participant contacting finder to recover lost item.

19. The automated lost property recovery and marketing system of claim 18 wherein said promotions and advertising function comprises: sponsor creating promotional message; sponsor communicating promotional message to administrator; sponsor designating participants from sponsor database to receive promotional message; administrator transmitting promotional message via E-mail over administrator's network to sponsor designated participants.
